(19) United States
(12) Patent Application Publication
(10) Pub. No.: US 2014/0120379 A1
(43) Pub. Date: May 1, 2014

(54) BATTERY PACK

(71) Applicant: SAMSUNG SDI CO., LTD., Yongin-City (KR)

(72) Inventors: Woon-Seong Baek, Yongin-City (KR); Hyung-Shin Kim, Yongin-City (KR); Yeong-Mi Kim, Yongin-City (KR)

(73) Assignee: Samsung SDI Co., Ltd., Yongin-City (KR)

(21) Appl. No.: 13/836,199

(22) Filed: Mar. 15, 2013

Related U.S. Application Data
(60) Provisional application No. 61/721,239, filed on Nov. 1, 2012.

(51) Int. Cl. H01M 2/02

(52) U.S. Cl. CPC H01M 2/0202
USPC 429/7; 429/186

(57) ABSTRACT

A battery pack includes a bare cell; a holder case positioned at the top of the bare cell; and a top case that covers the holder case. In the battery pack, a protruding portion is formed in a short side portion of the holder case, and a receiving portion is formed at a position corresponding to the protruding portion in the top case. Accordingly, the protruding portion is inserted into the receiving portion, so that it is possible to provide the battery pack stronger against external impact.

### CROSS-REFERENCE TO RELATED APPLICATIONS

This application claims the benefit of U.S. Provisional Application No. 61/721,239 filed Nov. 1, 2012 which is hereby incorporated by reference in its entirety.

### BACKGROUND OF THE INVENTION

1. Field of the Invention

An aspect of the present invention relates to a battery pack.

2. Description of the Related Art

Recently, battery packs have been variously used as power sources of portable electronic devices. As the portable electronic devices are used in various fields, demands on battery packs have rapidly increased. The battery packs can be charged/discharged a plurality of times, and accordingly are economically and environmentally efficient. Thus, the use of the battery packs is encouraged.

A battery pack is developed to increase the capacity of the battery pack as the usage of a smart phone increases. The increase in the capacity of the battery pack is connected to an increase in the weight of the battery pack, which causes problems including breakdown of a case, depression of the battery pack, etc.

### SUMMARY

Embodiments provide a battery pack which is strong against external impact by employing a new structure.

According to an aspect of the present invention, there is provided a battery pack, including: a bare cell; a holder case positioned at the top of the bare cell; and a top case that covers the holder case, wherein a protruding portion is formed in a short side portion of the holder case, and a receiving portion is formed at a position corresponding to the protruding portion in the top case.

The section of the protruding portion may be formed in a rounded or rectangular shape.

The protruding portion may be formed with a plurality of protruding portions.

The protruding portions may be respectively formed in both short side portions of the holder case.

The protruding portion may be inserted into the receiving portion.

The battery pack may further include a protective circuit module which is disposed at the top of the holder case, and is received in an internal space of the top case.

The protective circuit module may further include first and second lead plates coupled to the bottom surface of the protective circuit module. The first lead plate may be electrically connected to an electrode terminal of the bare cell through a first through-hole formed at a position corresponding to the first lead plate in the holder case, and the second lead plate may be electrically connected to the top surface of the bare cell through a second through-hole formed at a position corresponding to the second lead plate in the holder case.

The holder case may further include a support portion extended from a portion adjacent to the second through-hole thereof, and the top case may be supported by the support portion.

A stepped portion is formed at one side of the support portion, and one side of the protective circuit module may be mounted on the stepped portion.

The holder case may further include a guide portion formed to extend in the direction of the protective circuit module from a side surface of the holder case. The protective circuit module may further include a notch portion formed on the side surface of the protective circuit module, and the guide portion may be coupled to the notch portion.

A first fastening portion may be formed on the side surface of the holder case, and a second fastening portion coupled to correspond to the first fastening portion may be formed on the side surface of the top case.

The battery pack may further include an adhesive member which is disposed between the holder case and the bare cell, and fixes the holder case to the bare cell.

A fixing projection may be formed at one side of the top surface of the bare cell, and a fixing hole corresponding to the fixing projection may be formed in the holder case.

A battery pack comprising a bare cell having a first surface; a holder case positioned adjacent the first surface of the bare cell; a top case having two long side portions and two short side portions that define an opening that receives the holder case, wherein the top case also has at least one receiving portion formed adjacent the at least one of the short side portions and wherein at least one protrusion is formed as part of the holder case so as to extend into the at least one receiving portion.

Other features and advantages of the present invention will become more fully apparent from the following detailed description, taken in conjunction with the accompanying drawings.

Terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

According to the present invention, it is possible to provide a battery pack in which the inside of a short-side portion of a top case is filled, so that the battery pack is stronger against external impact.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view of a completed battery pack according to an embodiment of the present invention.

FIG. 2 is an exploded perspective view of the battery pack shown in FIG. 1.

FIG. 3 is an enlarged perspective view illustrating a coupling relationship of a holder case, a protective circuit module and a top case, shown in FIG. 2.

FIGS. 4A and 4B are sectional views taken along line A-A of FIG. 1 illustrating two different embodiments.

FIG. 5 is a perspective view illustrating a holder case according to another embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

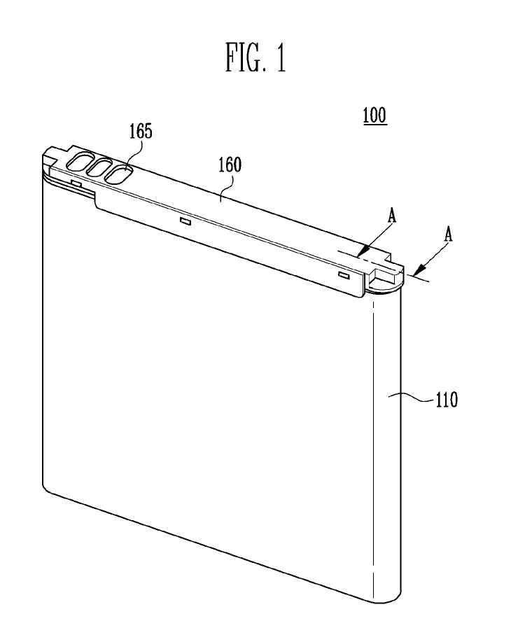

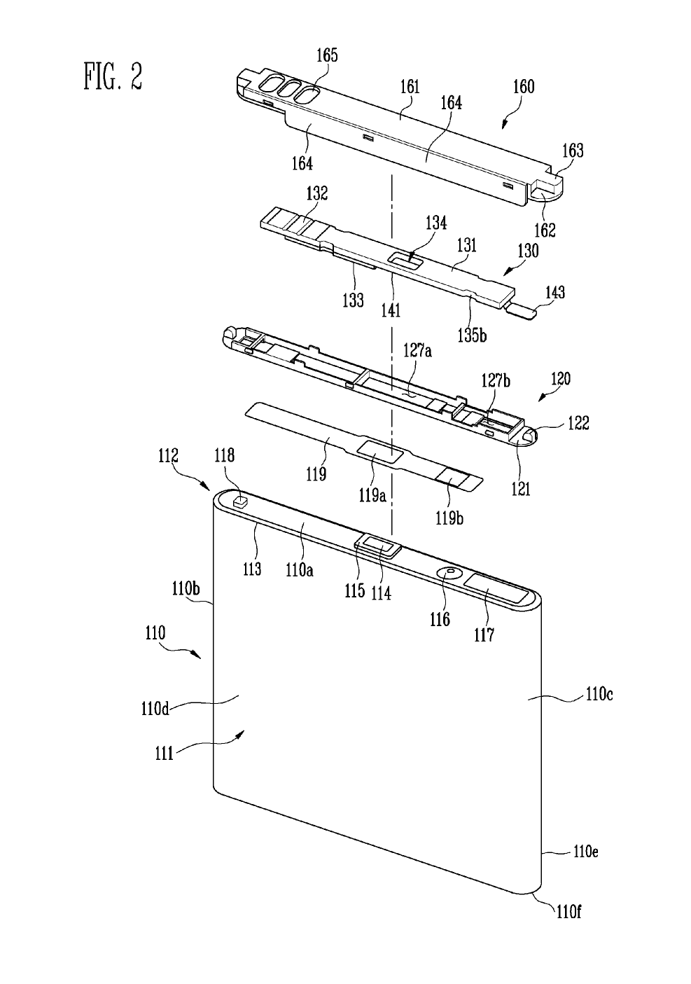

FIG. 1 is a perspective view of a completed battery pack according to an embodiment of the present invention. FIG. 2 is an exploded perspective view of the battery pack shown in FIG. 1.

Referring to FIGS. 1 and 2, the battery pack 100 according to this embodiment may include a bare cell 110, a holder case 120, a protective circuit module 130 and a top case 160.

The holder case 120 is disposed on the top of the bare cell 110, and the protective circuit module 130 is disposed on the top of the holder case 120. The top case 160 is disposed on the top of the protective circuit module 130.

The bare cell 110 may include an electrode assembly (not shown) having a positive electrode, a negative electrode and a separator interposed between the positive and negative electrodes; a container-type can 111 which is made of metal and accommodates the electrode assembly and an electrolyte (not shown); and a cap assembly 112 that seals an opening of the can 111.

Here, the cap assembly 112 may include a cap plate 113 formed of metal, an electrode terminal 114 coupled to the cap plate 113 so as to protrude from the cap plate 113, and a gasket 115 interposed between the cap plate 113 and the electrode terminal 114 so as to insulate the electrode terminal 114 from the cap plate 113.

The bare cell 110 may, as shown in FIG. 2, include a top surface 110a from which the electrode terminal 114 is protruded, a pair of short side surfaces 110b and 110c and a pair of long side surface 110d and 110e, which are connected to the top surface 110a, and a bottom surface 110f which is connected to the side surfaces 110b, 110c, 110d and 110e and is opposite to the top surface 110a. Here, the pair of short-side surfaces 110b and 110c are side surfaces having a narrow width among the side surfaces 110b, 110c, 110d and 110e connected to the top surface 110a of the bare cell 110, and the pair of long side surfaces 110d and 110e are side surfaces having a wide width among the side surfaces 110b, 110c, 110d and 110e connected to the top surface 110a of the bare cell 110.

An electrolyte injection hole 116 is formed at one side of the cap assembly 112. The electrolyte injection hole 116 is a portion through which the electrolyte is injected into the can 111, and the electrolyte is injected into the can 111 after the cap assembly 112 is assembled to the opening formed at the top of the can 111. Subsequently, the electrolyte injection hole 116 through which the electrolyte is injected into the can 111 is sealed with a separate sealing means formed of metal containing aluminum. Additionally, the electrolyte injection hole 116 can block the inflow of external air by coating a sealing member that is the separate sealing means on the top of the electrolyte injection hole 116. The electrolyte injection hole 116 having the sealing member coated thereon may have a convex shape such as a hemispherical shape.

A safety vent 117 is formed at the other side of the cap assembly 112. The safety vent 117 is formed thinner than the cap plate 113. If the internal pressure of the bare cell 110 is greater than the operating pressure of the safety vent 117, the safety vent 117 is opened to exhaust gas to the outside of the bare cell 110.

The holder case 120 may be attached to the top surface 110a of the bare cell 110 by an adhesive member 119 disposed between the top surface 110a of the bare cell 110 and the holder case 120.

Openings 119a and 119b may be formed in the adhesive member 119 so that the electrode terminal 114, the gasket 115 and the electrolyte injection hole 116 are protruded therethrough. Here, the adhesive member 119 may attach the holder case 120 to the bare cell 110 using at least one of a separate adhesive and a double-faced tape.

A protruding portion 122 is formed in the direction of the top case 160 on a short side portion 121 of the holder case 120, and a receiving portion 163 is formed at a position corresponding to that of the protruding portion 122 in the top case 160. The coupling structure between the protruding portion 122 and the receiving portion 163 will be described in detail later.

The protective circuit module 130 is disposed on the top of the holder case 120, and may include a circuit board 131, an external terminal portion 132, a positive temperature coefficient (PTC) 133 and a through-hole 134.

The circuit board 131 is formed with a plate made of resin, and includes a circuit (not shown) that controls charging/discharging of the bare cell 110 or a protective circuit (not shown) such as a circuit that prevents overcharging/overdischarging of the bare cell 110.

The external terminal portion 132 is mounted on a top surface of the circuit board 131, and functions to electrically connect the circuit board 131 and an external electronic device (not shown) to each other.

The PTC 133 is mounted on a bottom surface of the circuit board 131. If the temperature inside the bare cell 110 increases, the resistance of the PTC 133 increases, and thus the PTC 133 blocks the flow of current.

The through-hole 134 is formed by passing through the top and bottom surfaces of the circuit board 131. The through-hole 134 is positioned to correspond to the electrode terminal 114. At least one of the width and length of the through-hole 134 is formed shorter than the width and length of the electrode terminal 114. Therefore, the electrode terminal 114 does not pass through the through-hole 134.

A first lead plate 141 disposed at a lower portion of the circuit board 131 is electrically connected to the electrode terminal 114 through a first through-hole 127a of the holder case 120. The first lead plate 141 acts as a passage through which current from the electrode terminal 114 is transferred to the PTC 133. The first lead plate 141 may be made of metal, e.g., nickel or nickel alloy.

A second lead plate 143 is coupled to the circuit board 131 at one side of the circuit board 131 so as to be electrically connected to a positive electrode wiring pattern (not shown) of the protective circuit module 130. The second lead plate 143 is extended to be connected to the top surface 110a of the bare cell 110 by passing through a second through-hole 127b of the holder case 120, so that the bare cell 110 and the protective circuit module 130 are electrically connected by the second lead plate 143. That is, the second lead plate 143 is electrically connected to the top surface 110a of the bare cell 110 (i.e., acts as the positive electrode by being formed with the cap plate 113), so as to act as the positive electrode. The second lead plate 143 may be made of metal, e.g., nickel or nickel alloy.

The top case 160 covers the holder case 120 disposed at the top of the bare cell 110, and accommodates the protective circuit module 130 in an internal space thereof. The top case 160 may include a case plate 161 and a side wall 164 extended in the direction of the protective circuit module 130 from the case plate 161.

The top case 160 may be formed to have a shape approximately similar to the top surface 110a of the bare cell 110. The inner surface of the case plate 161 comes in contact with the top surface of the circuit board 131. The case plate 161 includes a terminal hole 165 formed in a region corresponding to the external terminal portion. The terminal hole 165 exposes the external terminal portion 132 to the outside of the battery pack 100, so that the battery back 100 can be electrically connected to the external electronic device (not shown).

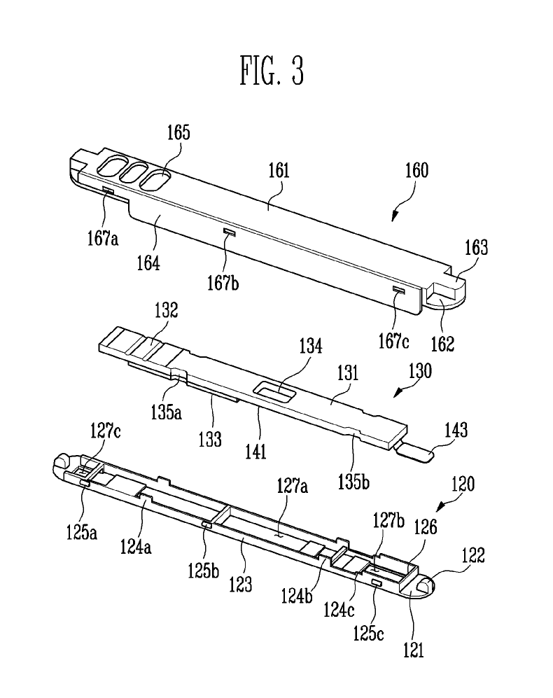

FIG. 3 is an enlarged perspective view illustrating a coupling relationship of the holder case, the protective circuit module and the top case, shown in FIG. 2.

Referring to FIG. 3, the holder case 120 includes guide portions 124a and 124b formed to extend in the direction of the protective circuit module 130 from sides of the holder case 120. The protective circuit module 130 may further include notch portions 135a and 135b formed at sides thereof. The guide portions 124a and 124b are coupled to the respective notch portions 135a and 135b so as to guide the position of the protective circuit module 130 on the holder case 120. Each of the guide portions 124a and 124b may be provided with a pair of guide portions respectively formed at both side surfaces 123 of the holder case 120.

The holder case 120 may include a support portion 126 extended from a portion adjacent to the second through-hole 127b of the holder case 120. When the holder case 120 is covered by the top case 160, the support portion 126 may be adhered closely to the bottom surface of the top case 160 so as to support the top case 160.

A stepped portion 124c may be formed at one side of the support portion 126 of the holder case 120. One side of the protective circuit module 130 having the second lead plate 143 coupled thereto is mounted on the stepped portion 124c so as to be guided on the holder case 120.

A fixing hole 127c is formed at one side of the holder case 120. The fixing hole 127c is coupled to a fixing projection (118 of FIG. 2) formed corresponding to the fixing hole 127 at one side of the top surface 110a of the bare cell 110, so that the holder case 120 can be guided on the bare cell 110.

First fastening portions 125a, 125b and 125c for coupling the holder case 120 to the top case 160 may be formed at the side surface 123 of the holder case 120. The first fastening portions 125a, 125b and 125c are respectively inserted and fixed into second fastening portions 167a, 167b and 167c formed at the side wall 164, corresponding to the positions of the first fastening portions 125a, 125b and 125c, so that the top case 160 and the holder case 120 can be coupled to each other.

The receiving portion 163 having a groove formed in the direction of the holder case 120 is formed in a short side portion 162 of the case plate 161. Generally, a space for accommodating the protective circuit module 130 is formed inside the top case 160, and an empty space is also formed inside the short side portion 162 of the top case 160. Therefore, the short side portion 162 of the top case 160 may be recessed or broken by impact caused when the battery pack 100 drops.

To solve such a problem, the top case 160 may be injection-molded so that no empty space exists inside the short side portion 162, but, in this case, a non-molded portion may be formed.

Thus, in the present invention, the protruding portion 122 is formed in the direction of the top case 160 in the short side portion 121 of the holder case 120, and is filled in the empty space in the receiving portion 163 by being inserted into the receiving portion 163, so that it is possible to prevent the short side portion 162 of the top case 160 from being recessed by external impact.

The short-side portion 121 of the holder case 120 has a surface structure, so that the protruding portion 122 can be easily injection-molded. The protruding portion 122 is an internal component received by the top case 160. Therefore, although the non-molded portion is formed in the injection molding, a problem occurring in the exterior appearance of the battery pack 100 is minute. According to an embodiment, the protruding portions 122 may be respectively formed in both the short side portions 121 of the holder case 120.

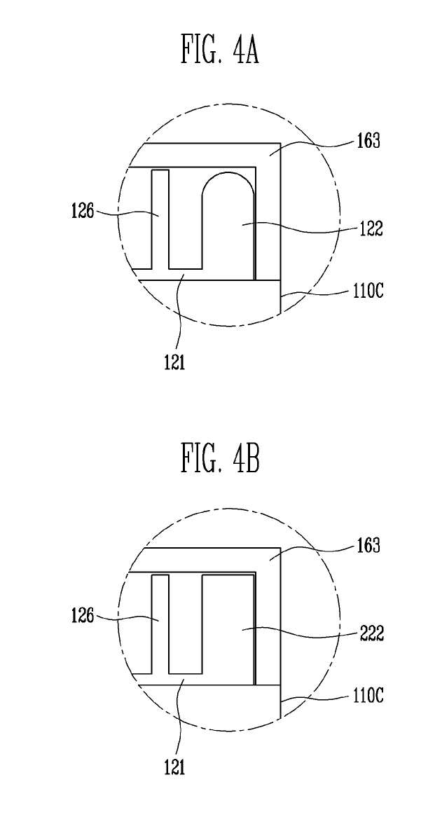

FIG. 4 is a sectional view taken along line A-A of FIG. 1.

Referring to FIG. 4A, the protruding portion 122 is formed on the short side portion 121 of the holder case 120. The protruding portion 122 is inserted into the receiving portion 163 of the top case 160 so as to be filled in the receiving portion 163. The support portion 126 may be adhered closely to the bottom surface of the top case 160. In this case, the support portion 126 functions to support the top case 160.

As shown in FIG. 4A, the protruding portion 122 may have a rounded shape. The protruding portion 122 can be easily inserted into the receiving portion 163 due to the rounded shape.

According to another embodiment, a protruding portion 222 may have a rectangular shape as shown in FIG. 4B.

In a case where the protruding portion 222 has a rectangular shape, the protruding portion 222 can be effectively filled in the empty space inside the receiving portion 163, and accordingly, it is possible to provide the battery pack 100 stronger against external impact.

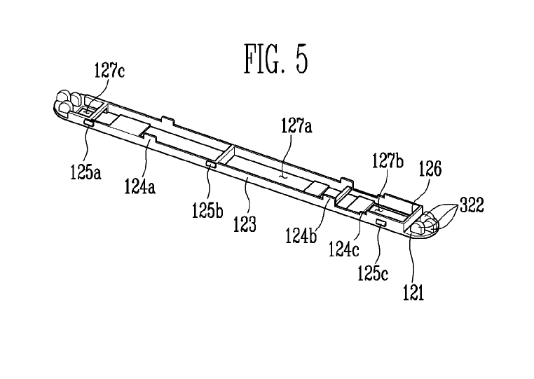

FIG. 5 is a perspective view illustrating a holder case according to another embodiment of the present invention.

As shown in FIG. 5, a protruding portion 322 of the holder case 120 according to this embodiment is provided with a plurality of protruding portions. In a case where the protruding portion 322 according to this embodiment is inserted into the receiving portion 163 of the top case 160, external impact can be dispersed due to the shape of the plurality of protruding portions, and accordingly, it is possible to provide the battery pack 100 stronger against the external impact.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof

What is claimed is:

1. A battery pack comprising:
a bare cell having a first surface;
a holder case positioned adjacent the first surface of the bare cell;
a top case having two long side portions and two short side portions that define an opening that receives the holder case, wherein the top case also has at least one receiving portion formed adjacent the at least one of the short side portions and wherein at least one protrusion is formed as part of the holder case so as to extend into the at least one receiving portion.

2. The battery pack of claim 1, wherein the at least one of the two short side portions of the top case has two flanges adjacent the long side portions that are positioned adjacent the opening in the top case and a raised portion that defines the at least one receiving portion interposed between the two flanges that is raised above the flanges and includes a space that receives the at least one protrusion.

3. The battery pack of claim 1, wherein the at least one protrusion comprises a plurality of protrusions.

4. The battery pack of claim 1, wherein the at least one receiving portion comprises a first and a second receiving portions positioned adjacent the first and second short side portions of the top case.

5. The battery pack of claim 1, wherein the at least one receiving portion receives the at least one protrusion without interconnecting with the at least one protrusion to reinforce the at least one receiving portion.

6. The battery pack of claim 5, wherein the at least one receiving portion has a first depth to a surface of the at least one receiving portion that defines the depth of the opening in the receiving portion and the at least one protrusion has a first length less than the first depth so that the at least one protrusion extends into the at least one receiving portion but is spaced from the surface of the receiving portion.

7. The battery pack of claim 1, further comprising a protection circuit module positioned within the holder case.

8. The battery pack of claim 7, wherein the protection circuit module includes a lead plate that interconnects the protection circuit module to the bare cell.

9. The battery pack of claim 8, wherein the lead plate comprises a first and a second lead plate wherein the first lead plate is connected to an electrode terminal of the bare cell through a first through hole in the holder case and the second lead plate is connected to the first surface of the bare cell through a second through hole in the holder case.

10. The battery pack of claim 7, wherein at least one holder case is adhesively coupled to the first surface of the bare cell.

11. The battery pack of claim 7, wherein the top case is coupled with the holder case so as to define an opening that receives the protection circuit module.

12. The battery pack of claim 1, wherein the top case includes a side surface with at least one first connecting portion formed therein and the holder case defines a side surface with at least one second connecting portion formed thereon wherein the at least one first connecting portion of the top case engages with the at least one second connecting portion in the holder case to retain the holder case and the top case together.

13. The battery pack of claim 1, wherein the holder case further includes a support portion adjacent the at least one protrusion so as to support the top case.

14. The battery pack of claim 13, wherein a step portion is formed at one side of the support portion that receives a side of the protection circuit module.

15. The battery pack of claim 7, wherein the holder case further includes a guide formed to extend in the direction of the protection circuit module from a side surface of the holder case and wherein the protection circuit module includes a notch that engages with the guide.

16. The battery pack of claim 1, wherein a section of the at least one protrusion has a rounded shape.

17. The battery pack of claim 1, wherein a section of the at least one protrusion has a rectangular shape.

18. The battery pack of claim 1, wherein a fixing projection is formed on the first surface of the bare cell and a fixing hole is formed on the holder case that receives the fixing projection.
